(19) United States
(12) Patent Application Publication
(10) Pub. No.: US 2019/0349578 A1
(43) Pub. Date: Nov. 14, 2019

(54) IMAGE COMPONENT DELINEATION IN A VIDEO TEST AND MEASUREMENT INSTRUMENT

(71) Applicant: Tektronix, Inc., Beaverton, OR (US)

(72) Inventor: Lakshmanan Gopishankar, Beaverton, OR (US)

(73) Assignee: Tektronix, Inc., Beaverton, OR (US)

(21) Appl. No.: 16/404,585

(22) Filed: May 6, 2019

Related U.S. Application Data
(60) Provisional application No. 62/668,727, filed on May 8, 2018.

(51) Int. Cl. H04N 17/02; G06T 5/00

(52) U.S. Cl. CPC H04N 17/02; G06T 2207/20208; G06T 2207/10016; G06T 5/009

(57) ABSTRACT

A test and measurement instrument may include a video test and measurement system that delineates or otherwise indicates various components of an electronic image to enable a user to discern the various components that make up a picture display. The device may delineate an image into those regions having High Dynamic Range (HDR) region and those regions having SDR range. The delineated display mode may be a new mode on a video waveform monitor.

### PRIORITY

This disclosure claims benefit of U.S. Provisional Application No. 62/668,727, titled “FALSE COLOR DELINEATION IN A VIDEO TEST AND MEASUREMENT INSTRUMENT,” filed on May 8, 2018, the contents of which is incorporated herein by reference in its entirety.

### TECHNICAL FIELD

This disclosure is directed to systems and methods related to video test and measurement systems, and in particular, to false color identification in a video test and measurement system.

### BACKGROUND

A contrast range of an image is its range between light and dark areas of the image. High Dynamic Range (HDR) image content has a contrast range that is larger than standard content, such as a Standard Dynamic Range (SDR) image. HDR has the effect of enhancing details of the image in both the highlight areas and lowlight areas. Sometimes HDR content may be generated by combining multiple images, each having a standard dynamic range, while in other cases some high definition cameras may natively generate HDR content. In some video production workflows it is very important to be able to distinguish HDR content from SDR, as well as to be able to determine a range of the HDR content. Not all workflows, however, have the ability to distinguish HDR content from other content and or provide a range of the content.

Embodiments of the disclosure address these and other deficiencies of the prior art.

### BRIEF DESCRIPTION OF THE DRAWINGS

Aspects, features and advantages of embodiments of the present disclosure will become apparent from the following description of embodiments in reference to the appended drawings in which:

FIG. 1 is a block diagram of an example Video Waveform Monitor including false color delineation according to embodiments of the disclosure.

FIG. 2 is a graph that illustrates and example luma vs. alpha transfer according to some embodiments of the disclosure.

FIG. 3 is an example flow diagram including example operations according to some embodiments of the disclosure.

### DESCRIPTION

Disclosed herein is a video test and measurement system that delineates or otherwise indicates various components of an electronic image to enable a user to discern the various components that make up a picture display. In some embodiment the regions delineated are those regions having High Dynamic Range (HDR) region. The delineated display mode may be a new mode on a video waveform monitor, for instance.

Such a delineated display mode could be particularly beneficial in a video production workflow space where producers or others who process HDR video content have a need to easily see which areas of scenes of interest have HDR content. In addition, there may be a need to have an idea of the range of HDR content that is present in those regions.

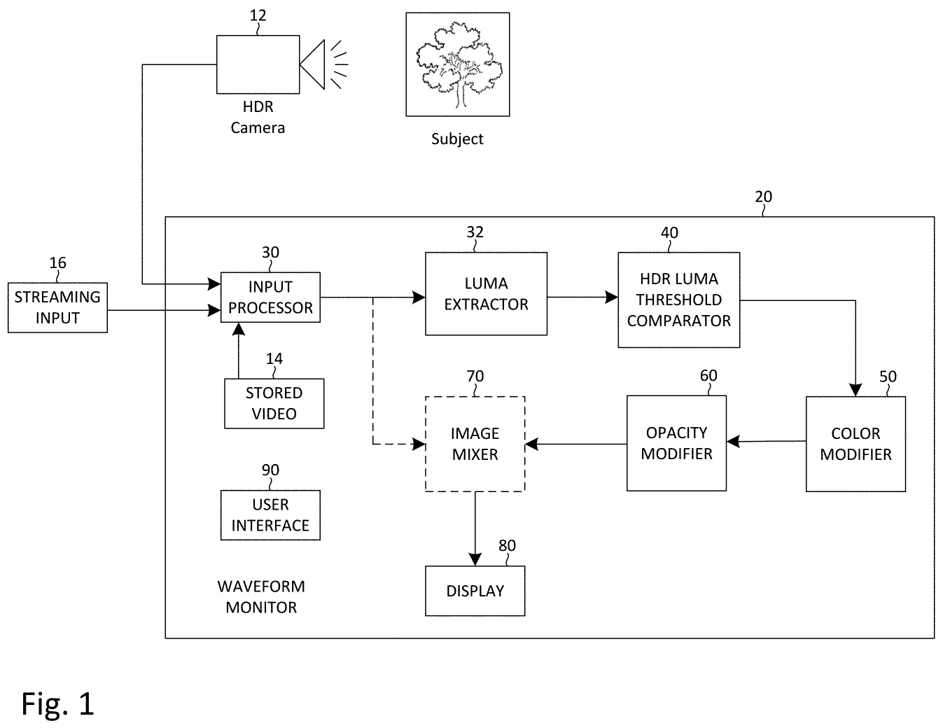

FIG. 1 is a block diagram showing material portions of an example test instrument, such as a Video Waveform Monitor, according to embodiments of the invention. As illustrated in FIG. 1, a Waveform Monitor 20 includes an input processor 30 that initially processes video input into one or more images. Such video may come from an HDR camera 12, from stored video 14, or from a video stream 16, such as video delivered Over The Top (OTT) of Ethernet or other data transfer standards, for example. Embodiments of the invention are capable of operating with any type of video source, and are not limited to merely the options listed here.

The video content may include HDR content, i.e., content that has higher dynamic range than standard image content. After the Waveform Monitor 20 accepts the video input, the input processor 30 assembles the video into one or more images of data. In other embodiments the Waveform Monitor 20 may accept images directly, rather than processing the video input into one or more images.

Depending on the scene being recorded by the HDR camera 12, or depending on how the video data was created that was stored in the video storage 14 or streamed through the streaming input 16, the images made from the video content may include HDR content. The HDR content may be located in only portions of the images. In other words, HDR content may appear in one or more areas of the image, but typically all areas of the image will not contain HDR content. Also, it is possible that no HDR content is included in some of the images. The non-HDR content of the image or images is standard content.

As mentioned above, the video data received by the Waveform Monitor 20 is first processed by an input processor 30 to be assembled into a series of images in a known manner. The input processor 30 may include memory to store the incoming data from video source before the data is assembled into the images. Other data or image processing may also occur in the input processor 30, if the user desires additional processing.

After being generated, modified, or passed through the input processor 30, a luminance value of the images is determined in a luma extractor 32. In some embodiments, the luma extractor 32 may be embodied in a separate processor, but typically the luma extractor 32 is a function operating on one or more programmed general or special purpose processors within the Waveform Monitor 20. The luma extractor 32 generates a luma component of a portion of an image, such as an individual pixel. In other words, the luma extractor 32 generates a value that indicates how bright a portion of the image is. In some embodiments a luma value is generated for every pixel of data within the image. In other embodiments an average luma value may be generated for a region of the image. Although this description describes the luma extraction and evaluation process in terms of pixels, for brevity, one of skill in the art will understand that these techniques may be performed on groups of pixels, of various sizes, in various embodiments.

Once generated, the luminance value of the pixel may be examined in a threshold comparator 40 to determine whether the pixel includes HDR content. In some embodiments, HDR content is that content of an image that includes a luminance value that exceeds a luminance threshold value. The luminance threshold value may be set at a level that delineates HDR content from SDR content. In other words, a pixel having a luminance value that is higher than the luminance threshold value is considered to be HDR content. Embodiments of the invention delineate HDR content from SDR content and generate an image that allows the user to easily identify that content that is HDR and other content that is non-HDR, or SDR content. In some embodiments a pixel luminance that exactly equals the luminance threshold may be considered to be an HDR pixel, while in other embodiments such a pixel may be determined to be a SDR pixel.

In some embodiments the threshold comparator 40 simply compares the particular pixel luminance to a fixed threshold, and pixels with luminance values that meet or exceed the luminance threshold are deemed to contain HDR content. In other embodiments the luminance threshold may be variable and controlled by a user. In this way the user can control which pixels will be flagged as containing HDR content, which may provide more flexibility and greater control to the user.

In other embodiments the threshold comparator 40 may include several different thresholds based on the way an HDR image is encoded. Different encoding methods of HDR encoding may have different luminance thresholds for determining HDR content. In other words, HDR images encoded by one method may have a luminance threshold value that is different than HDR images encoded by another method.

In other embodiments the luminance threshold may be based on an overall average luminance value of the image. For example, the luminance threshold may be set so that pixels having a luminance value in the top 20% of all of the luminance values are deemed to be HDR content. In yet other embodiments, the luminance threshold may be based on a determined standard deviation of pixel values with the frame or a region of the frame, etc. It will be appreciated that the above listed threshold examples are chosen for illustrative purposes only, and other methods of calculating luminance threshold values or comparing pixel luminance values to the luminance threshold are possible.

Once the luminance value of a pixel, or groups of pixels, in the image has been identified as containing HDR content, or SDR content, the pixel may be modified to be assembled into a modified image to be shown to a user on a display 80 (FIG. 1), or otherwise presented to a user. In some embodiments the modified images may be stored for later access.

In some embodiments, pixels having a value below the luminance threshold, i.e., pixels that have been identified as SDR pixels, are modified to reduce color content of the pixels. A common image storage format describes color information of a pixel by a number between 0 and 255 for each of red, green, and blue (RGB). So, a particular pixel may have RGB values of 112, 204, and 116, respectively. With reference back to FIG. 1, some embodiments of the invention use a color modifier 50 to modify the color for the SDR pixels. This has the effect of reducing the intensity or de-emphasizing those pixels. In some embodiments SDR pixels have their color content reduced to 25% of their original color. In such an embodiment the pixel having RGB of 111, 204 and 116 values would be modified to RGB 28, 51, and 29 and stored in the modified image in the same location as the original image. After processing by the color modifier 50, all of the SDR pixels within the image are reduced to 25% of their original color value, which has the effect of de-emphasizing or reducing the color intensity of the SDR pixels in the modified image. The color modifier 50 may calculate each color independently, or may use other techniques, such as a Look-Up-Table (LUT) or other techniques to perform the color conversion.

Of course, the selection of how much to reduce the color content of the SDR pixels and even whether to reduce all of the color by the same percentage may be controlled in some embodiments of the invention. For example the Waveform Monitor 20 may include a user interface 90 that includes user-interactive menus or controls so that the user may make such modifications. In other embodiments the SDR pixels of the original image may have all color removed so that they are converted into greyscale in the modified image. In yet other embodiments the SDR pixels may be set to a particular static color. In still other embodiments the SDR pixels are not modified at all and instead only the HDR pixels are modified when creating the modified image, as described below. Although RGB values 0-255 are used in the above examples, those skilled in the art can apply the above-described techniques of color intensity or color modification to images that use other image definition protocols.

The above description explained how the pixels within an image that are identified as SDR may be modified. In addition, embodiments of the invention include techniques for modifying those pixels within an image that are identified as containing HDR content.

In some embodiments those pixels containing HDR content are modified by setting the pixels to a set color and adjusting an opacity of the pixels. In some embodiments the opacity varies with the luminance value. The opacity of the HDR pixels may be modified in an opacity modifier 60 within the Waveform Monitor 20 of FIG. 1. The opacity modifier is illustrated as a functional block in FIG. 1, but may be implemented as a program operating on a processor, in an FPGA, or using other methods as described below.

In this description opacity is described by variable called alpha. An alpha value of 1 is opaque while an alpha value of 0 is completely transparent to a pre-set background, which in various embodiments may be pre-set to all black, all white, or to something in between. In embodiments where an output image, or output frame, is initially set to all black, a pixel set to an alpha value being completely opaque is mixed with none of the black background. Conversely, when the alpha value is completely transparent, then only the black background would show for that pixel in the final image.

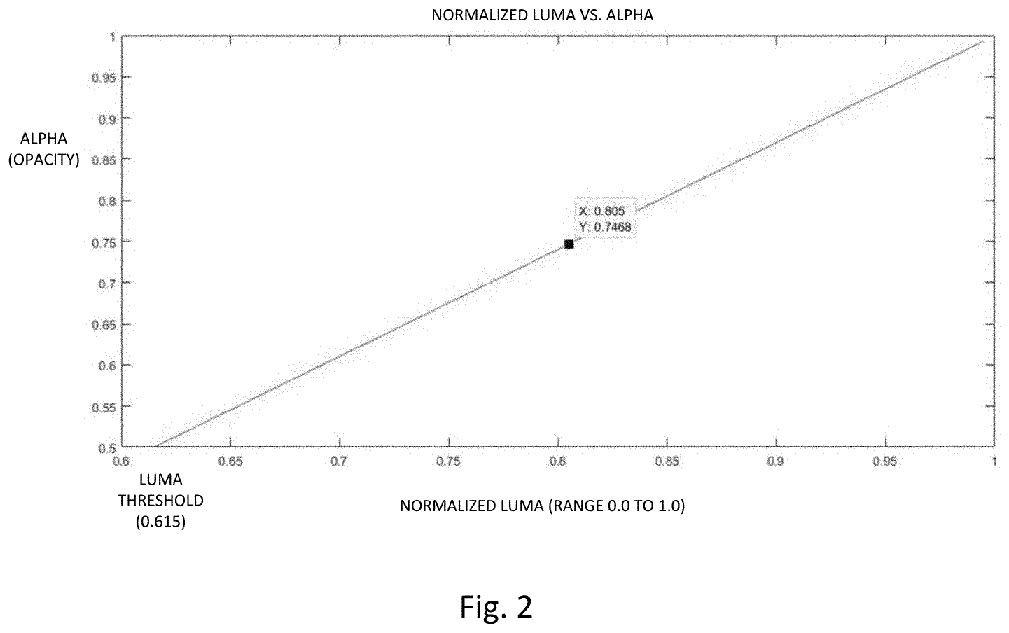

Setting alpha may be controlled by a function, which may be a function of the luminance. An example luminance to alpha function is illustrated in FIG. 2. In this figure, the luminance value is normalized to a range of 0.0 to 1.0. The x axis of FIG. 2 describes the normalized luminance values from a selected threshold value of 0.615 to 1.0. The y-axis of FIG. 2 describes the alpha (opacity) factor that is applied to those pixels. FIG. 2 is obtained using an example luminance threshold value of 0.615. For pixels with luminance value above the threshold, the opacity value for those pixels are as defined in the FIG. 2. For example, a pixel having a normalized luminance value of 0.8 will be ascribed to an alpha value of approximately 0.74. Other normalized luminance values will cause other alpha levels to be ascribed, with higher luma values having higher alpha values.

The luma/alpha function illustrated in FIG. 2 is described by Equation (1):

alpha=(0.5*(luma−threshold)/(1.0−threshold))+0.5 Equation (1):

Recall in the above example that HDR pixels may be set to a predetermined color value. Then, using the alpha function described above, the transparency of the HDR pixels may be set according to the luminance value. This has the effect of the pixels that have higher luminance values in the original image will appear more opaque in the output image, while the pixels that have lower luminance values will appear more transparent through to the initial background color. Recall that, in some embodiments, the alpha values are assigned only to those pixels that had an initial luminance value higher than the luminance threshold. Those pixels having luminance values lower than the luminance threshold are classified as SDR pixels, and are processed differently, such as by lowering their color values to make them less intense.

Although one example luminance to alpha function is described in FIG. 2, other functions may be applied, and the functions need not have straight lines. All such functions fall within embodiments of the invention. In some embodiments the user may select or even design the luminance to alpha function using one or more menus or controls through the user interface 90 of the waveform monitor 20 (FIG. 1).

The following pseudo code, which can be applied to each pixel of a target frame, illustrates an example implementation:

```
If (luma > threshold)
{
    Color.a = (0.5 * (luma − threshold)/(1.0 − threshold)) + 0.5;
    Color.r = 0;
    Color.g = 1.0;
    Color.b = 1.0;
}
Else
{
    Color.r = Color.r/4;
    Color.g = Color.g/4;
    Color.b = Color.b/4;
    Color.a = 1.0;
}
```

In the pseudo code above, luma reflects a luminance value for a selected pixel, threshold is the HDR luminance threshold discussed above, color.r references the red value for the selected pixel, color.g references the green value for the selected pixel, color.b references the blue value for the selected pixel, and color.a references the alpha value (i.e., opaqueness) for the selected pixel.

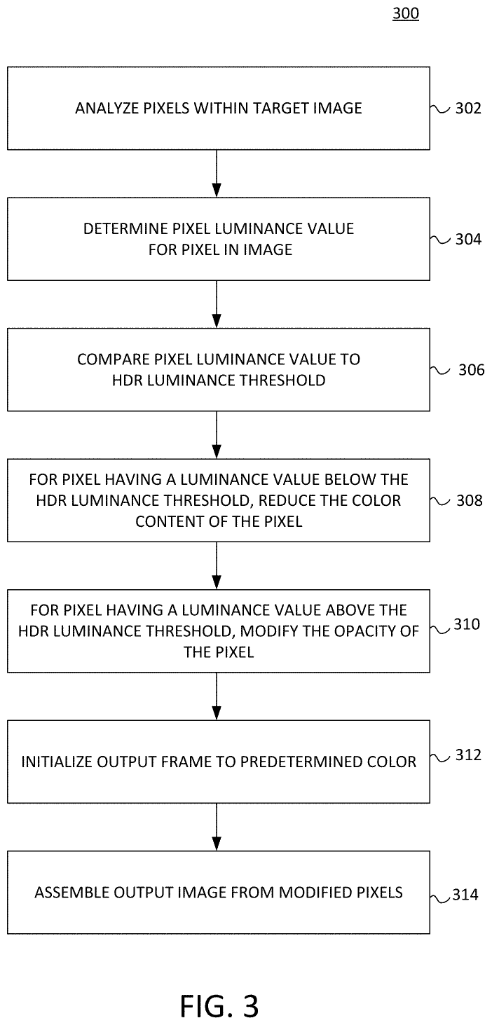

FIG. 3 is a flow chart illustrating example operations for creating a modified image from a target image as described above. A flow 300 begins at an operations 302 and 304 by analyzing and determining luminance values for pixels in a target image. The target image may be one generated by the image processor 30 (FIG. 1) as described above.

The pixel luminance values are compared to an HDR luminance threshold in an operation 306. As described above, the threshold may be user controlled, and there may be more than one threshold depending on type or coding technique used to create the target image. Those pixels having a luminance value below the target value are classified as SDR pixels and may be modified to identify them as such. As described above, in some embodiments the color values may be reduced to reduce the intensity of the pixel color in an operation 308.

Those pixels having a luminance value above the luminance threshold are classified as HDR pixels. In an operation 308, the HDR-classified pixels may be delineated and shown to a user in a modified image by modifying an opacity of the pixel according to its luminance value as described above. One luma to alpha function is illustrated in FIG. 2, although other functions are possible.

Once the SDR and HDR pixels have been classified and modified, a new image may be assembled. In an operation 312 an output frame for the modified image is initialized. In some embodiments the output frame is initialized to all black, while in other embodiments the output frame may be initialized to all white. Then, in an operation 314, the modified image is assembled by inserting the SDR modified pixels and the HDR modified pixels in the same location they were in the initial, target image. The final modified image may be output to a display 80 (FIG. 1) or may be stored for later viewing.

Although several embodiments of the invention were described above, there are other modifications that may be made still within the scope of the invention. For example, the above operations described classifying SDR pixels as those having a luminance value below a luminance threshold and HDR pixels as having a luminance value above the luminance threshold. It is possible to include a third classification between the SDR and HDR classifications. In such an embodiment the pixels in the third classification could pass from the original target image to the output image without changing. FIG. 1 includes an optional image mixer 70, which provides such a pass-through function. Also, although the above-described embodiments discussed modifying both the SDR and HDR classified pixels, it is possible that some embodiments modify only one or the other. Selection of these modes may be made through the user interface 90. Finally, each of the inventive aspects described above may operate independently or in conjunction with other independent aspects.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the technologies disclosed herein are provided below. An embodiment of the technologies may include any one or more, and any combination of, the examples described below.

Example 1 a test and measurement instrument including an extractor configured to determine a luminance value of a portion of an original image; a comparator configured to classify the luminance of the portion of the image based on the luminance value and based on a threshold; a pixel modifier structured to set an opacity of the portion of the image based on the classification of the portion of the image; and an assembler configured to create a modified image using the modified portion of the original image.

Example 2 is a test and measurement instrument of Example 1, further comprising a color modifier configured to modify a color intensity of the portion of the original image based on the classification of the portion of the image.

Example 3 is a test and measurement instrument of Example 1 or Example 2, in which the pixel modifier sets an opacity only for those portions of the image classified in a first classification, and in which the color modifier modifies the color intensity only for those portions of the image classified in a second classification.

Example 4 is a test and measurement instrument of Examples 1, 2 or 3, in which the threshold is a luminance threshold.

Example 5 is a test and measurement instrument of Examples 1 through 4, further comprising an image processor structured to receive a video input and to produce the original image from the video input.

Example 6 is a test and measurement instrument of Example 5, in which the video input is received from a camera, from a stored file, or from a video streaming source.

Example 7 is a test and measurement instrument of any of the preceding Examples, in which the pixel modifier is additionally structured to set the opacity of the portion of the image based on the contents of the portion of the image.

Example 8 is a test and measurement instrument of Example 7, in which the contents of the portions of the image includes a luminance value of the portions of the image.

Example 9 is a test and measurement instrument of any of the preceding Examples, in which the assembler is additionally configured to create the modified image using a base image in which all of the portions of the image are initialized identically.

Example 10 is a method for generating a modified image by a test and measurement instrument, comprising: determining a luminance value of a portion of an original image; comparing the luminance value to a luminance threshold to generate a first classification of portions of the original image and a second classification of portions of the original image; for those portions of the original image in the first classification, setting an opacity of those portions of the image to modify those portions; and creating the modified image using the modified portion of the original image.

Example 11 is a method according to Example 10, further comprising, for those portions of the original image in the second classification, modifying a color intensity of the portions of the original image.

Example 12 is a method according to Example 10 or 11, in which modifying a color intensity of the portions of the original image comprises reducing the color intensity.

Example 13 is a test and measurement instrument of any of the preceding Examples 10-12, in which setting an opacity of those portions of the image to modify those portions comprises setting the opacity of the portion of the image based on the luminance of the portion of the image.

Example 14 is a test and measurement instrument of any of the preceding Examples 10-13, further comprising generating the original image from a video input.

Example 15 is a test and measurement instrument of any of the preceding Examples 10-14, in which creating the modified image using the modified portion of the original image further comprises creating the modified image using a base image in which all of the portions of the image are initialized identically.

Example 16 is one or more computer-readable storage media comprising instructions, which, when executed by one or more processors of a test and measurement instrument, cause the test and measurement instrument to: determine a luminance value of a portion of an original image; compare the luminance value to a luminance threshold to generate a first classification of portions of the original image and a second classification of portions of the original image; for those portions of the original image in the first classification, set an opacity of those portions of the image to modify those portions; and create the modified image using the modified portion of the original image.

Example 17 is the one or more computer-readable storage media of Example 16, further comprising instructions configured to cause the test and measurement instrument, for those portions of the original image in the second classification, to modify a color intensity of the portions of the original image.

Example 18 is the one or more computer-readable storage media of any of preceding Examples 16-17, further comprising instructions configured to cause the test and measurement instrument to generate the original image from a video input.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A test and measurement instrument, comprising:
an extractor configured to determine a luminance value of a portion of an original image;
a comparator configured to classify the luminance of the portion of the image based on the luminance value and based on a threshold;
a pixel modifier structured to set an opacity of the portion of the image based on the classification of the portion of the image; and
an assembler configured to create a modified image using the modified portion of the original image.

2. The test and measurement instrument of claim 1, further comprising a color modifier configured to modify a color intensity of the portion of the original image based on the classification of the portion of the image.

3. The test and measurement instrument of claim 2, in which the pixel modifier sets an opacity only for those portions of the image classified in a first classification, and in which the color modifier modifies the color intensity only for those portions of the image classified in a second classification.

4. The test and measurement instrument of claim 1, in which the threshold is a luminance threshold.

5. The test and measurement instrument of claim 1, further comprising an image processor structured to receive a video input and to produce the original image from the video input.

6. The test and measurement instrument of claim 5, in which the video input is received from a camera, from a stored file, or from a video streaming source.

7. The test and measurement instrument of claim 1, in which the pixel modifier is additionally structured to set the opacity of the portion of the image based on the contents of the portion of the image.

8. The test and measurement instrument of claim 7, in which the contents of the portions of the image includes a luminance value of the portions of the image.

9. The test and measurement instrument of claim 1, in which the assembler is additionally configured to create the modified image using a base image in which all of the portions of the image are initialized identically.

10. A method for generating a modified image by a test and measurement instrument, comprising:
determining a luminance value of a portion of an original image;
comparing the luminance value to a luminance threshold to generate a first classification of portions of the original image and a second classification of portions of the original image;
for those portions of the original image in the first classification, setting an opacity of those portions of the image to modify those portions; and
creating the modified image using the modified portion of the original image.

11. The method for generating a modified image by a test and measurement instrument of claim 10, further comprising, for those portions of the original image in the second classification, modifying a color intensity of the portions of the original image.

12. The method for generating a modified image by a test and measurement instrument of claim 11, in which modifying a color intensity of the portions of the original image comprises reducing the color intensity.

13. The method for generating a modified image by a test and measurement instrument of claim 10, in which setting an opacity of those portions of the image to modify those portions comprises setting the opacity of the portion of the image based on the luminance of the portion of the image.

14. The method for generating a modified image by a test and measurement instrument of claim 10, further comprising generating the original image from a video input.

15. The method for generating a modified image by a test and measurement instrument of claim 10, in which creating the modified image using the modified portion of the original image further comprises creating the modified image using a base image in which all of the portions of the image are initialized identically.

16. One or more computer-readable storage media comprising instructions, which, when executed by one or more processors of a test and measurement instrument, cause the test and measurement instrument to:
determine a luminance value of a portion of an original image;
compare the luminance value to a luminance threshold to generate a first classification of portions of the original image and a second classification of portions of the original image;
for those portions of the original image in the first classification, set an opacity of those portions of the image to modify those portions; and
create the modified image using the modified portion of the original image.

17. The one or more computer-readable storage media of claim 16, further comprising instructions configured to cause the test and measurement instrument, for those portions of the original image in the second classification, to modify a color intensity of the portions of the original image.

18. The one or more computer-readable storage media of claim 16, further comprising instructions configured to cause the test and measurement instrument to generate the original image from a video input.
